(19) United States
(12) Patent Application Publication
(10) Pub. No.: US 2012/0268806 A1
(43) Pub. Date: Oct. 25, 2012

(54) INKS WITH FLUORINATED MATERIAL-SURFACE MODIFIED PIGMENTS

(76) Inventors: Zhang-Lin Zhou, Palo Alto, CA (US); Jong-Souk Yeo, Corvallis, OR (US); Qin Liu, Corvallis, OR (US)

(21) Appl. No.: 13/091,462

(22) Filed: Apr. 21, 2011

(51) Int. Cl. G02F 1/167; C09D 11/00

(52) U.S. Cl. 359/296; 106/31.6; 106/31.65; 106/31.75

(57) ABSTRACT

Pigment-based inks with fluorinated material-surface modified pigments are provided. The inks include a non-polar carrier fluid, and pigment particles suspended in the non-polar carrier fluid. The pigment particles either have fluorinated acidic functional groups, which are charged through basic charge directors to give negatively charged pigment dispersions, or have fluorinated basic functional groups, which are charged thorough acidic charge directors to give positively charged pigment dispersions. A combination of an electronic display and an electronic ink is also provided, as is a method for modifying the pigment particles.

### BACKGROUND

Ultrathin, flexible electronic displays that look like print on paper are of great interest for potential applications in wearable computer screens, electronic paper, smart identity cards, store shelf labels and other signage applications. Electrophoretic or electrokinetic displays are an important approach to this type of medium. Electrophoretic/kinetic actuation relies on particles moving under the influence of an electric field, so the desired particles must exhibit good dispersibility and charge properties in non-polar dispersing media. Non-polar dispersing media are desirable because they help minimize the leakage currents in electrophoretic/kinetic devices.

Current commercial products based on electrophoretic display technology are only able to provide color and white states or black and white states. They cannot provide a clear, or transparent, state, which prevents use of a stacking architecture design. Such a stacking architecture of layered colorants would allow the use of transparent to colored state transitions in each layer of primary subtractive color to show print-like color in one display.

### BRIEF DESCRIPTION OF THE DRAWINGS

FIG. 1 depicts a cross-sectional view of an example of a stacked electro-optical display.

FIG. 2 is a schematic diagram of a first reaction scheme, according to an example.

FIG. 3 is a schematic diagram of a second reaction scheme, according to an example.

FIG. 4 is a schematic diagram of a third reaction scheme, according to an example.

FIG. 5 is a schematic diagram of a fourth reaction scheme, according to an example.

FIG. 6A shows a reflective mode image of white electronic ink using an example fluorinated material surface-treated pigments in a display element in the dark state.

FIG. 6B is similar to FIG. 6A, but in the clear state with a black absorber underneath.

FIG. 7 illustrates a cross-sectional view of one example of a lateral electro-optical display.

### DETAILED DESCRIPTION

Aspects of the present invention were developed in relation to electronic inks, but the specification and claims are not so limited.

In the following detailed description, reference is made to the accompanying drawings which form a part hereof, and in which is shown by way of illustration specific examples in which the disclosure may be practiced. In this regard, directional terminology, such as “top,” “bottom,” “front,” “back,” “leading,” “trailing,” etc., is used with reference to the orientation of the Figure(s) being described. Because components of examples can be positioned in a number of different orientations, the directional terminology is used for purposes of illustration and is in no way limiting. It is to be understood that other examples may be utilized and structural or logical changes may be made without departing from the scope of the present disclosure. The following detailed description, therefore, is not to be taken in a limiting sense, and the scope of the present disclosure is defined by the appended claims.

As used herein, the term “grayscale” applies to both black and white images and monochromatic color images. Grayscale refers to an image including different shades of a single color produced by controlling the density of the single color within a given area of a display.

As used herein, the term “over” is not limited to any particular orientation and can include above, below, next to, adjacent to, and/or on. In addition, the term “over” can encompass intervening components between a first component and a second component where the first component is “over” the second component.

As used herein, the term “adjacent” is not limited to any particular orientation and can include above, below, next to, and/or on. In addition, the term “adjacent” can encompass intervening components between a first component and a second component where the first component is “adjacent” to the second component.

As used herein, the term “electronic ink display” is a display that forms visible images using one or more of electrophoresis, electro-convection, electroosmosis, electrochemical interactions, and/or other electrokinetic phenomena.

The article ‘a’ and ‘an’ as used in the claims herein means one or more.

Bi-state and/or tri-state electrophoretic display cells (or elements) having a three-dimensional architecture for compacting charged colorant particles within the display cells are described in US Patent Publication 2010/0245981, published Sep. 30, 2010. A bi-state display cell having a dark state and a clear state is provided by an electronic ink with charged colorant particles in an optically transparent fluid. A clear state is achieved when the colorant particles are compacted and a colored state is achieved when the colorant particles are spread. An electronic ink with charged white particles in a colored fluid enables white and spot-color states, with the color of the colored state depending on the color of the fluid. The ink fluid is colored by a dye, nanoparticle colorants, pigments, or other suitable colorants. A white state is achieved when the white particles are spread and a colored state is achieved when the white particles are compacted. By combining the white particles in the colored fluid with a colored resin on the back of the display cell, a tri-state display cell is provided.

An electrophoretic/electrokinetic display cell may include a three-dimensional architecture to provide a clear optical state. In this architecture, the geometrical shape of the display cell has narrowing portions in which electrophoretically/electrokinetically translated colorant particles compact in response to appropriate bias conditions applied to driving electrodes on opposite sides of the display cell. The three-dimensional structure of the display cell introduces additional control of electrophoretically/electrokinetically moving colorant particles. As a result, desired functionalities can be achieved with a relatively well developed and more stable electrophoretic/electrokinetic ink. The driving electrodes are passivated with a dielectric layer, thus eliminating the possibility of electrochemical interactions through the driving electrodes from direct contact with the electrophoretic/electrokinetic ink. In other examples, the driving electrodes are not passivated, thus allowing electrochemical interactions with the electrophoretic/electrokinetic ink.

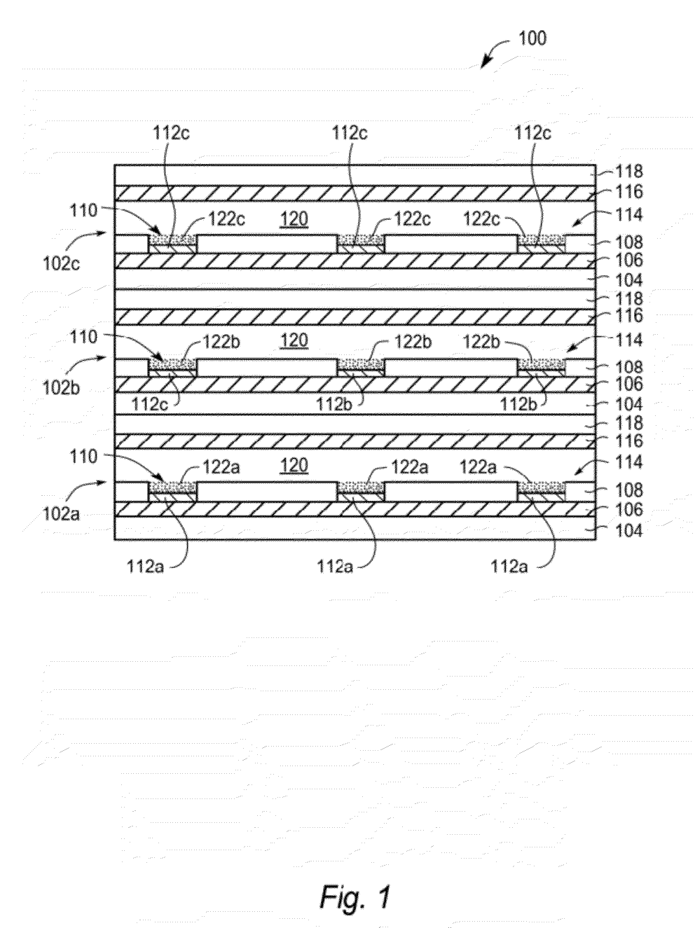

An example of a stacked device architecture is shown in FIG. 1. This configuration allows stacking of colored layers for electrophoretic or electrokinetic displays.

FIG. 1 illustrates a cross-sectional view of one example of stacked electro-optical display 100. Electro-optical display 100 includes a first display element 102a, a second display element 102b, and a third display element 102c. Third display element 102c is stacked on second display element 102b, and second display element 102b is stacked on first display element 102a.

Each display unit includes a first substrate 104, a first electrode 106, a dielectric layer 108 including reservoir or recess regions 110, thin layers 112, a display cell 114, a second electrode 116, and a second substrate 118. Display cell 114 is filled with a carrier fluid 120 with colorant particles 122. In some examples, thin layers 112 may be opaque. In other examples, thin layers 112 may be transparent.

First display element 102a includes thin layers 112a self-aligned within recess regions 110. First display element 102a also includes colorant particles 122a having a first color (e.g., cyan) for a full color electro-optical display.

Second display element 102b includes thin layers 112b self-aligned within recess regions 110. Second display element 102b also includes colorant particles 122b having a second color (e.g., magenta) for a full color electro-optical display.

Third display element 102c includes thin layers 112c self-aligned within recess regions 110. Third display element 102c also includes colorant particles 122c having a third color (e.g., yellow) for a full color electro-optical display. In other examples, colorant particles 122a, 122b, and 122c may include other suitable colors for providing an additive or subtractive full color electro-optical display.

In the example illustrated in FIG. 1, in the electro-optical display 100, first display element 102a, second display element 102b, and third display element 102c are aligned with each other. As such, thin layers 112a, 112b, and 112c are also aligned with each other. In this example, since recess regions 110 and self-aligned thin layers 112a, 112b, and 112c of each display element 102a, 102b, and 102c, respectively, are aligned, the clear aperture for stacked electro-optical display 100 is improved compared to a stacked electro-optical display without such alignment.

In an alternate example (not shown), first display element 102a, second display element 102b, and third display element 102c may be offset from each other. As such, thin layers 112a, 112b, and 112c are also offset from each other. In this example, since recess regions 110 and self-aligned thin layers 112a, 112b, and 112c are just a fraction of the total area of each display element 102a, 102b, and 102c, respectively, the clear aperture for stacked electro-optical display 100 remains high regardless of the alignment between display elements 102a, 102b, and 102c. As such, the process for fabricating stacked electro-optical display 100 is simplified. The self-aligned thin layers 112a, 112b, and 112c prevent tinting of each display element due to colorant particles 122a, 122b, and 122c, respectively, in the clear optical state. Therefore, a stacked full color electro-optical display having a bright, neutral white state and precise color control is provided.

As indicated above, this architecture enables both clear and colored states. However, developing electronic inks that work in this architecture has been challenging. The materials used in presently-available commercial products do not work in this architecture, since they do not provide clear states. Significant progress toward developing working electronic inks for this architecture has been made; see, e.g., PCT/US2009/060971 (“Electronic Inks”); PCT/US2009/060989 (“Dual Color Electronically Addressable Ink”); and PCT/US2009/060975 (“Electronic Inks”), all filed Oct. 16, 2009.

These electronic inks are based on functionalized pigments with additional surfactants and charge directors, in which both charges and stabilization are not covalently bonded to the pigment surface. In this case, the pigment can lose charge over a long time of switching, and the pigment can also lose the stabilization of the dispersant which is adsorbed on the pigment surface.

Surface modification of TiO₂ pigment using random polymerization method to introduce polymer onto TiO₂ pigment surface has been demonstrated, but this technique has its own drawbacks: only small portion of polymer is actually grafted onto the pigment surface, which leads to large portions of free polymer in the final products, which can then cause high background charges in electronic inks.

The prior art approach is to add polymeric dispersants or to modify the surface with regular alkyl groups, which gives reasonably well-dispersed pigments, but for inorganic pigments such as TiO₂ pigments, it often fails to give stable dispersions.

In accordance with the teachings herein, novel fluorinated material surface-modified, pigment-based electronic inks are provided. In an example, silica-coated pigments with subsequent surface modifications with fluorinated materials including fluorinated small molecules, oligomers and polymers, are provided. Improving the hydrophobicity and dispersibility of pigments in non-polar solvents may provide stable electronic inks, especially for inorganic pigments. In other words, a fluorinated material surface treatment via silane coupling chemistry with reactive fluorinated small molecules, oligomers and polymers is performed. The electronic inks based on these novel fluorinated materials surface treated pigments are much more stable with better switching behaviors and significantly improved lifetime compared to those without surface treatment or treated with non-fluorinated materials.

Both the hydrophobicity and dispersibility of pigments in non-polar solvents are considered in obtaining stable electronic inks, especially those employing inorganic pigments. Using the approach disclosed herein, the resulting pigments have more hydrophobic surfaces, which are more dispersible in non-polar solvents.

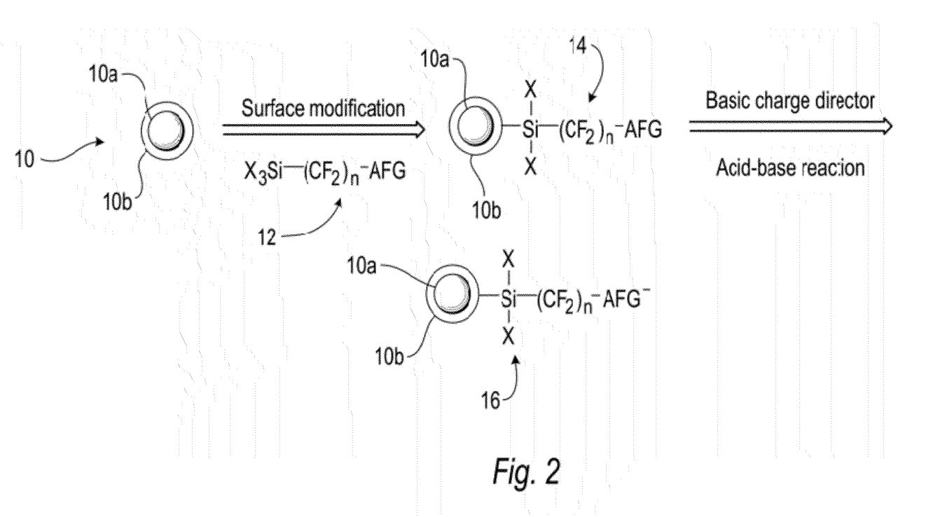

A first scheme, depicted in FIG. 2, is directed to a general example of a bare pigment particle 10a that is encapsulated within a thin layer 10b of silica layer that have hydroxyl groups on the surface to form a silica-coated pigment 10. The hydroxyl groups may react with a fluorinated silane reagent 12 having an acidic functional group to form a fluorinated acidic functional groups-modified pigment 14, which may be charged through certain basic charge directors to give stable and negatively charged pigment 16 dispersions. Basic charge directors are described in greater detail below.

In the scheme depicted in FIG. 2, the pigment particle 10a may represent any possible electrophoretic/kinetic particles with all possible colors such as RGB (Red-Green-Blue) or CYMK (Cyan-Yellow-Magenta-Black). The electrophoretic/kinetic particles 10a may comprise colored pigments or colored polymeric particles, with particle sizes ranging from 50 nm to 1 μm. In some examples, smaller particles, down to a few nm, such as quantum dots, may be employed. In other examples, the particle size may range to a few micrometers. Examples of pigments are described in greater detail below.

The thin layer 10b represents a thin layer of metal oxide such as silica, which has functional hydroxyl groups. Its thickness may range up to about 200 nm.

The letters AFG represent acidic functional groups or their corresponding salt forms. The acidic functional groups can be, but not limited to, —OH, —SH, —COOH, —CSSH, —COSH, —SO₃H, —PO₃H, —OSO₃H, —OPO₃H, etc. The percentage of AFG group on the encapsulating polymers or co-polymers can range from about 0.1% to 20% in some examples and from about 0.5% to 10% in other examples.

The letter X represents any functional group that can react with hydroxyl groups; non-limiting examples include —OH, Cl—, MeO—, EtO—, PrO—, etc., where Me=methyl, Et=ethyl, and Pr=propyl. The letter n represents an integer from 1 to 15.

The basic charge director represents any small molecule or polymer that can interact with acidic functional group to form charges. One such example includes, but is not limited to, a neutral and non-dissociable charge director such as a succinimide ashless dispersant primarily consisting of polyisobutylene succinimide, available from Chevron Oronite Company LLC (Bellaire, Tex.).

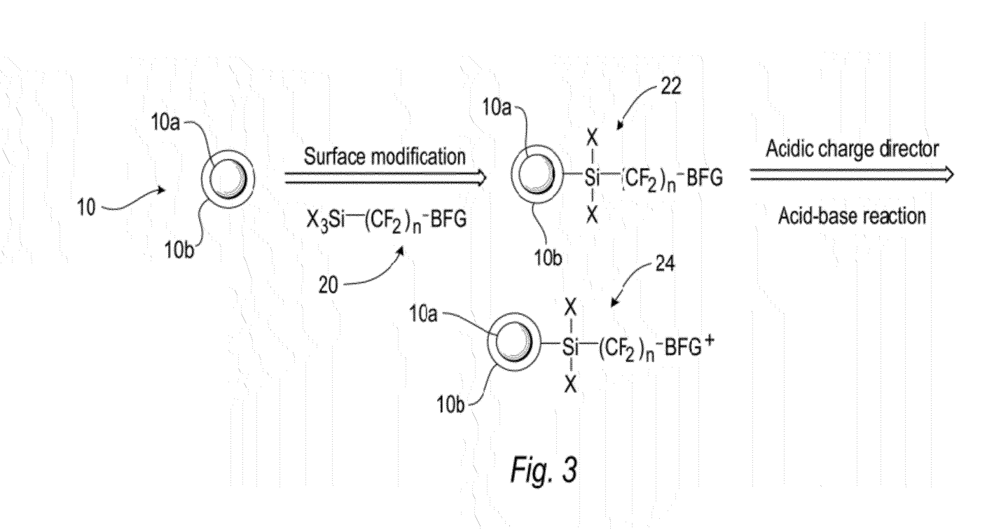

A second scheme, depicted in FIG. 3, is directed to a general example of a bare pigment particle 10a that is encapsulated within a thin layer of silica layer 10b that has hydroxyl groups on the surface to form a silica-coated pigment 10. The hydroxyl groups may react with a fluorinated silane reagent 20 having a basic functional group to form a basic functional groups-modified pigment 22, which can be charged thorough certain acidic charge directors to give stable and positively charged pigment 24 dispersions. Examples of acidic charge directors are described in greater detail below.

In the scheme depicted in FIG. 3, the pigment particle 10a and the thin layer 10b are as described above.

The letters BFG represents basic functional groups, which can be, but not limited to, trialkyamine, R₁R₂N—, pyridines or substituted pyridines, imidazoles or substituted imidazoles, wherein R₁ and R₂ can independently be any alkyl or branched alkyl groups, which include, but not limited to hydrogen, methyl, ethyl, propyl, isopropyl, butyl, iso-butyl, n-octyl, n-decyl, n-dodecyl, n-tetradecyl, etc.

The letter X represents any functional group that can react with hydroxyl groups; non-limiting examples include —OH, Cl—, MeO—, EtO—, PrO—, etc. The letter n represents an integer from 1 to 15.

The acidic charge director represents any small molecule or polymer that can interact with basic functional groups to form charges. One of such example includes, but is not limited to, a neutral charge director such as a polymeric dispersant consisting primarily of polyhydroxyaliphatic acid, available as Solsperse® from Lubrizol, Ltd. (Manchester, UK).

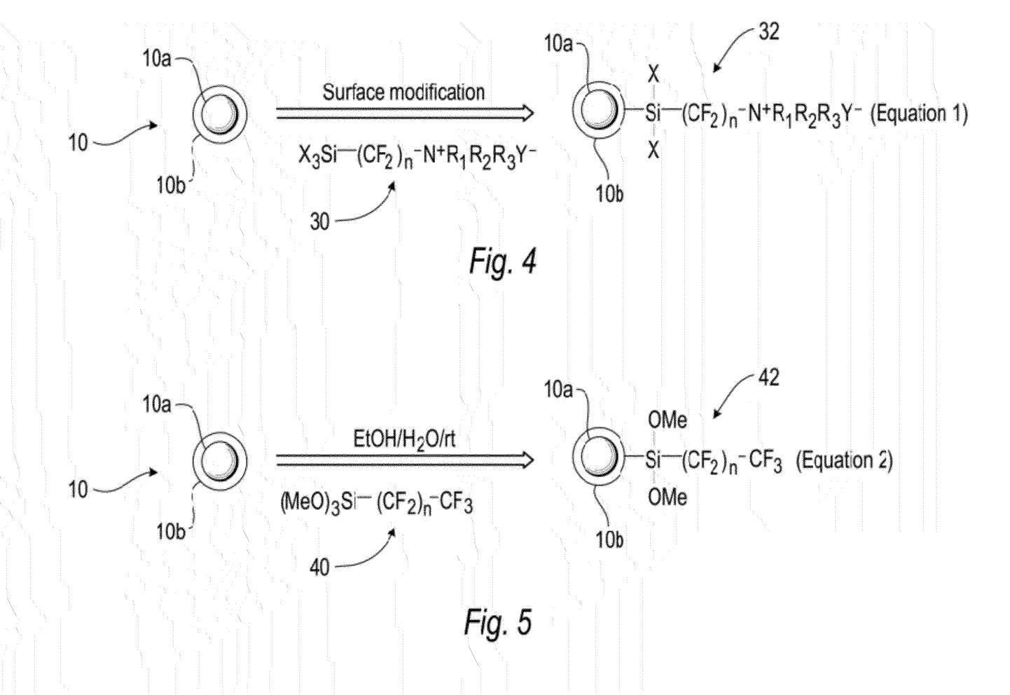

Equation 1, shown in FIG. 4, describes an example of such positively charged electronic pigments 32 that may be obtained by reaction of silica-coated pigments 10 with a reactive fluorinated silane reagent with quaternary ammonium salts 30, which can dissociate into positively charged electrophoretic particles and counter ion Y⁻ in a solvent. Such positive charges may be covalently bonded to the pigment surface, so the resulting electronic inks are more stable than those by adsorption of charged micelles.

In the equation depicted in FIG. 4, the pigment particle 10a and the thin layer 10b are as described above.

The letters R₁, R₂, and R₃ can independently be any alkyl or branched alkyl groups, which include, but not limited to hydrogen, methyl, ethyl, propyl, isopropyl, butyl, iso-butyl, n-octyl, n-decyl, n-dodecyl, n-tetradecyl, etc.

The letter X represents any functional group that can react with hydroxyl groups; non-limiting examples include —OH, Cl—, MeO—, EtO—, PrO—, etc. The letter n represents an integer from 1 to 15.

The letter Y represents any possible negative charged groups, such as halogen anion, carboxylic acid anion, phosphoric acid anion, sulfuric acid anion, hexafluorophosphorus anion, tetraphenyl boronic anion, etc.

Equation 2, shown in FIG. 5, is directed to another example of perfluoroakly group surface treatment on pigment surface. A coupling reaction of silica coated pigments 10 with reactive perfluorinated silane reagent 40 may form perfluoroalkyl groups covered pigments 42, which are much more dispersible in non-polar solvents.

In the equation depicted in FIG. 5, the pigment particle 10a and the thin layer 10b are as described above.

The letter n represents an integer from 1 to 15.

Below are listed a series of potential reactive fluorinated materials that can react with the hydroxyl groups on the pigment surfaces to introduce fluorinated materials including small molecules, oligomers, and polymers. They contain reactive functional groups such as acid chloride 1, active ester 2, isothiocyanate 3, and trimethoxysilanes 4 and 5. These reactive functional groups can all react with hydroxyl groups to form co-valent bonded fluorinated material treated pigment surfaces.

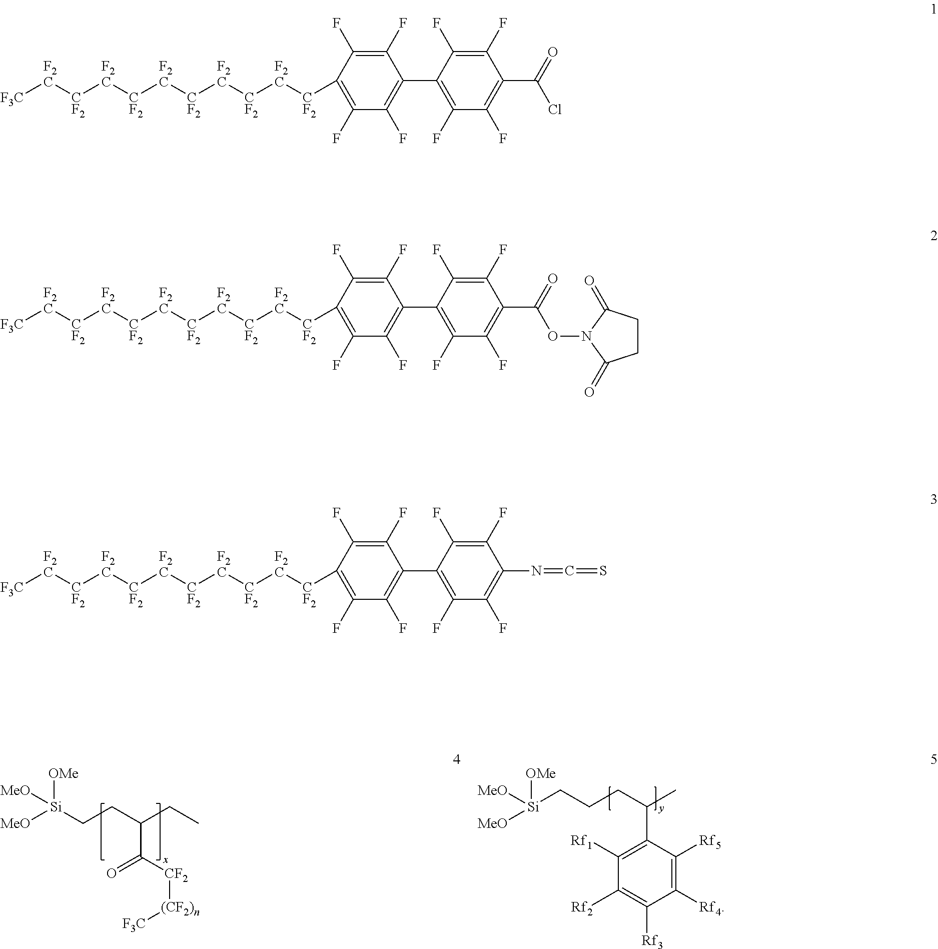

In the foregoing structures, Rf₁ to Rf₅ may independently be fluorinated alkyl groups or branched alkyl groups. The letters x, y, and z may independently ranges from 5 to 5,000.

Turning now to electronic inks that employ the functionalized pigments discussed above, examples of such electronic inks generally include a non-polar carrier fluid (i.e., a fluid having a low dielectric constant k such as, e.g., less than about 20, or, in some cases, less than about 2). Such fluids tend to reduce leakages of electric current when driving the display, as well as increase the electric field present in the fluid. As used herein, the “carrier fluid” is a fluid or medium that fills up a viewing area defined in an electronic ink display and is generally configured as a vehicle to carry colorant particles therein. In response to a sufficient electric potential or field applied to the colorant particles while driving electrodes of the display, the colorant particles tend to move and/or rotate to various spots within the viewing area in order to produce a desired visible effect in the display cell to display an image. The non-polar carrier fluid includes, for example, one or more non-polar carrier fluids selected from hydrocarbons, halogenated or partially halogenated hydrocarbons, and/or siloxanes. Some specific examples of non-polar carrier fluids include perchloroethylene, cyclohexane, dodecane, mineral oil, isoparaffinic fluids, cyclopentasiloxane, cyclohexasiloxane, cyclooctamethylsiloxane, and combinations thereof.

The colorant particles are dispersed in the carrier fluid. As used herein, the term “colorant particles” refers to particles that produce a color. Some non-limiting examples of suitable colorant particles include the surface-modified pigment particles described above. In a non-limiting example, the colorant particles are selected from pigment particles that are self-dispersible in the non-polar carrier fluid. It is to be understood, however, that non-dispersible pigment particles may otherwise be used so long as the electronic ink includes one or more suitable dispersants. Such dispersants include hyperdispersants such as those of the SOLSPERSE® series manufactured by Lubrizol Corp., Wickliffe, Ohio (e.g., SOLSPERSE® 3000, SOLSPERSE® 8000, SOLSPERSE® 9000, SOLSPERSE® 11200, SOLSPERSE® 13840, SOLSPERSE® 16000, SOLSPERSE® 17000, SOLSPERSE® 18000, SOLSPERSE® 19000, SOLSPERSE® 21000, and SOLSPERSE® 27000); various dispersants manufactured by BYKchemie, Gmbh, Germany, (e.g., DISPERBYK® 110, DISPERBYK® 163, DISPERBYK® 170, and DISPERBYK® 180); various dispersants manufactured by Evonik Goldschmidt GMBH LLC, Germany, (e.g., TEGO® 630, TEGO® 650, TEGO® 651, TEGO® 655, TEGO® 685, and TEGO® 1000); and various dispersants manufactured by Sigma-Aldrich, St. Louis, Mo., (e.g., SPAN® 20, SPAN® 60, SPAN® 80, and SPAN® 85).

In some examples, the concentration of pigment in the electronic ink ranges from about 0.5 to 20 percent by weight (wt %). In other examples, the concentration of the pigment ranges from about 1 to 10 wt %. In some examples, the concentration of dispersant in the electronic ink may range from about 0.5 to 20 percent by weight (wt %). In other examples, the concentration of the dispersant may range from about 1 to 10 wt %. The carrier fluid makes up the balance of the ink.

There is commonly a charge director employed in electronic inks. As used herein, the term “charge director” refers to a material that, when used, facilitates charging of the colorant particles. In an example, the charge director is basic and reacts with the acid-modified colorant particle to negatively charge the particle. In other words, the charging of the particle is accomplished via an acid-base reaction between the charge director and the acid-modified particle surface. It is to be understood that the charge director may also be used in the electronic ink to prevent undesirable aggregation of the colorant in the carrier fluid. In other cases, the charge director is acidic and reacts with the base-modified colorant particle to positively charge the particle. Again, the charging of the particle is accomplished via an acid-base reaction between the charge director and the base-modified particle surface.

The charge director may be selected from small molecules or polymers that are capable of forming reverse micelles in the non-polar carrier fluid. Such charge directors are generally colorless and tend to be dispersible or soluble in the carrier fluid.

In a non-limiting example, the charge director is selected from a neutral and non-dissociable monomer or polymer such as, e.g., a polyisobutylene succinimide amine, which has a molecular structure as follows:

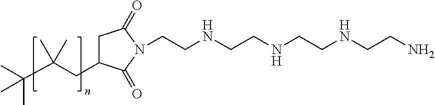

where n is selected from a whole number ranging from 15 to 100.

Another example of the charge director includes an ionizable molecule that is capable of disassociating to form charges. Non-limiting examples of such charge directors include sodium di-2-ethylhexylsulfosuccinate and dioctyl sulfosuccinate. The molecular structure of dioctyl sulfosuccinate is as follows:

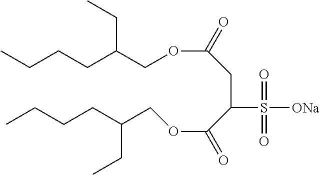

Yet another example of the charge director includes a zwitterion charge director such as, e.g., lecithin. The molecular structure of lecithin is as shown as

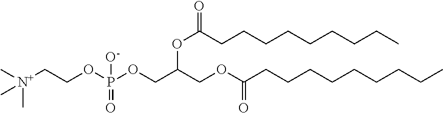

The foregoing discussion has been directed to the functionalization of TiO₂ pigment particles (white color). However, the teachings herein are equally applicable to other pigments, whether inorganic or organic, and of whatever color. Such inorganic and organic pigments are described further below, along with examples of different colors.

The pigment particles are selected from organic or inorganic pigments, and have an average particle size ranging from about 1 nm to about 10 μm. In some examples, the average particle size ranges from about 10 nm to about 1 μm. In other examples, the average particle size ranges from about 30 to 500 nm. Such organic or inorganic pigment particles may be selected from black pigment particles, yellow pigment particles, magenta pigment particles, red pigment particles, violet pigments, cyan pigment particles, blue pigment particles, green pigment particles, orange pigment particles, brown pigment particles, and white pigment particles. In some instances, the organic or inorganic pigment particles may include spot-color pigment particles, which are formed from a combination of a predefined ratio of two or more primary color pigment particles. To the extent that the generic pigments on the foregoing list can be functionalized as taught herein, such pigments may be used in the practice of the teachings herein. Likewise, to the extent that the following examples of specific pigments can be functionalized as taught herein, such pigments may be used in the practice of the teachings herein.

A non-limiting example of a suitable inorganic black pigment includes carbon black. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® L, MONARCH® 700, MONARCH® 800, MONARCH® 880, MONARCH® 900, MONARCH® 1000, MONARCH® 1100, MONARCH® 1300, and MONARCH® 1400); and various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). A non-limiting example of an organic black pigment includes aniline black, such as C.I. Pigment Black 1.

Other examples of inorganic pigments include metal oxides and ceramics, such as the oxides of iron, zinc, cobalt, manganese, nickel. Non-limiting examples of suitable inorganic pigments include those from the Shephord Color Company (Cinicinnati, Ohio) such as Black 10C909A, Black 10P922, Black 1G, Black 20F944, Black 30C933, Black 30C940, Black 30C965, Black 376A, Black 40P925, Black 411A, Black 430, Black 444, Blue 10F545, Blue 10G511, Blue 10G551, Blue 10K525, Blue 10K579, Blue 211, Blue 212, Blue 214, Blue 30C527, Blue 30C588, Blue 30C591, Blue 385, Blue 40P585, Blue 424, Brown 10C873, Brown 10P835, Brown 10P850, Brown 10P857, Brown 157, Brown 20C819, Green 10K637, Green 187 B, Green 223, Green 260, Green 30C612, Green 30C654, Green 30C678, Green 40P601, Green 410, Orange 10P320, StarLight FL 37, StarLight FL105, StarLight FL500, Violet 11, Violet 110, Violet 92, Yellow 10C112, Yellow 10C242, Yellow 10C272, Yellow 10P110, Yellow 10P225, Yellow 10P270, Yellow 196, Yellow 20P296, Yellow 30C119, Yellow 30C236, Yellow 40P140, Yellow 40P280.

In addition to the foregoing inorganic pigments that may have their surfaces fluorinated as taught herein, the same teachings may be employed with organic pigments. The following is a list of organic pigments that may be treated in accordance with the teachings herein.

Non-limiting examples of suitable yellow pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, Pigment Yellow 155, C.I. Pigment Yellow 167, C.I. Pigment Yellow 172, and C.I. Pigment Yellow 180.

Non-limiting examples of suitable magenta or red or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Non-limiting examples of blue or cyan organic pigments include C.I. Pigment Blue 1, C.I. Pigment Blue 2, C.I. Pigment Blue 3, C.I. Pigment Blue 15, C.I. Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Non-limiting examples of green organic pigments include C.I. Pigment Green 1, C.I. Pigment Green2, C.I. Pigment Green, 4, C.I. Pigment Green 7, C.I. Pigment Green 8, C.I. Pigment Green 10, C.I. Pigment Green 36, and C.I. Pigment Green 45.

Non-limiting examples of brown organic pigments include C.I. Pigment Brown 1, C.I. Pigment Brown 5, C.I. Pigment Brown 22, C.I. Pigment Brown 23, C.I. Pigment Brown 25, and C.I. Pigment Brown, C.I. Pigment Brown 41, and C.I. Pigment Brown 42.

Non-limiting examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

The colored electronic inks allow the construction of stacked color displays that have bright color, are readable under sun light, use low power and can be made flexible and light weight.

### EXAMPLES

### 1. Synthesis of Perfluorooctyl Group Surface Treated TiO₂ Nanoparticles

Into a 250 ml one-neck round bottom flask, TiO₂ nanoparticles (2 g, DuPont R960) were suspended in 80 ml methyl isobutyl ketone (MIBK) at room temperature for 1 hr. Perfluorooctyl(trimethoxy)silane (1.60 g, 4.87 mmol) was added afterwards and the solution was heated at reflux overnight. The excess starting material was removed through five cycles of centrifugation and resuspension in hexane.

Excess solvent was removed under vacuum oven for a period of 24 hrs. The surface treated titanium particles were obtained as a white powder (1.70, 85% yield).

### 2. Formulation of Electronic Inks Based on Perfluorooctyl Group Surface Treated TiO₂ Nanoparticles

Into a 50 ml milling bowl was added perfluorooctyl group surface-treated TiO₂ nanoparticles (0.7 g) from Example 1, OLOA 11000 (0.35 g), Solperse® 17000 (0.35 g), 5.6 g of ISOPAR®, and 50 μm milling beads (30 g). The mixture was allowed to mill for 60 min.

After cooling to room temperature, another 5.6 g of ISOPAR L was added. The resulting mixture was sonicated for another 30 min. The milling beads were filtered off to give 10% of functional white inks.

### 3. Formulation of Electronic Inks Based on Untreated TiO₂ Nanoparticles

Into a 50 ml milling bowl were added untreated TiO₂ nanoparticles (0.7 g) from Example 1, OLOA 11000 (0.35 g), Solperse® 17000 (0.35 g), 5.6 g of ISOPAR®, and 50 μm milling beads (30 g). The mixture was allowed to mill for 60 min.

After cooling to room temperature, another 5.6 g of ISOPAR was added. The resulting mixture was sonicated for another 30 min. The milling beads were filtered off to give 10% of functional white inks. The resulting inks aggregated after just 24 hours, it did not provide good switching performance, i.e. poor compaction and poor clearing.

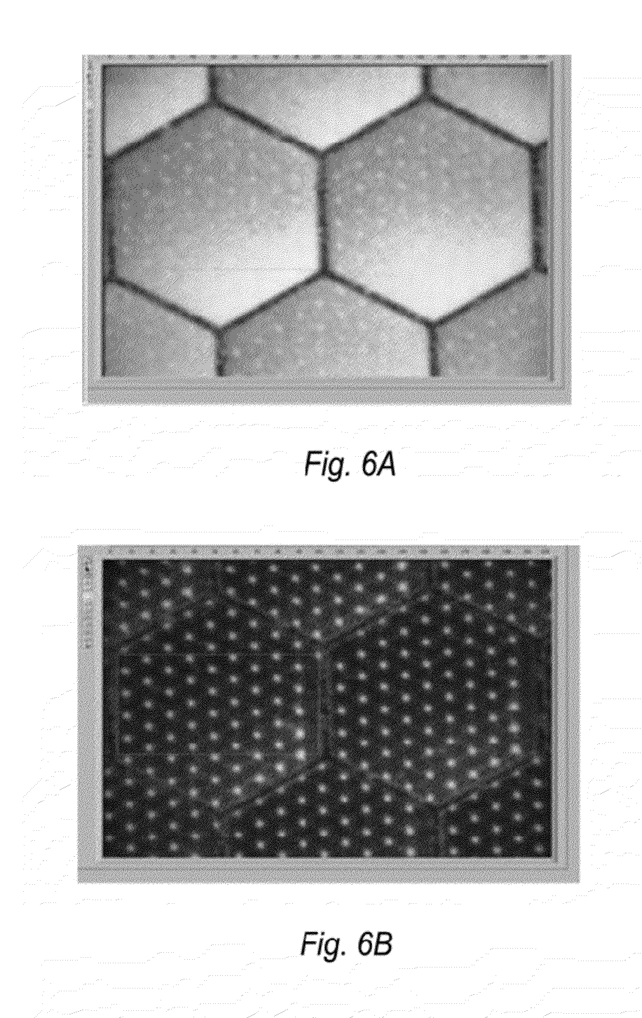

FIGS. 6A-6B show the images of the white electronic ink based on such fluorinated material surface treated pigments in a device comprising a single cell. FIGS. 6A-6B are reflective mode images of the white electronic ink in a dark state (FIG. 6A) and in a clear state with black absorber underneath (FIG. 6B). The images show that both dark and clear states can be obtained. The lifetime of the ink may last much longer, on the order of 2 to 10 times longer, than the inks based on pigments without surface modification or other non-fluorinated material treated pigments.

Thus, a novel category of surface treatments for pigment particles has been disclosed, involving perfluorinated small molecule surface treatment via silane coupling chemistry with reactive fluorinated small molecule, oligomer, and polymers. The resulted pigments have more hydrophobic surfaces and are more dispersible in non-polar solvents.

The extremely stable carbon-fluorine (C—F) bond in fluorinated materials makes them well known for their exceptional qualities such as hydrophobicity, solvophobicity, chemical inertness, thermal stability, low dielectric constant, and biocompatibility. These performances make fluorinated surfaces promising to design microsystems such as microfluidic devices, superhydrophobic surfaces, or micropatterned surfaces for the manipulation and growth of cells. Perfluorinated silanes allow the formation of chemically inert layers of the most hydrophobic and oleophobic films, which should be good candidates for designing surfaces with patterned wettabilities, chemical inertness and thermal stability.

The electronic inks based on these novel perfluorinated molecules are much more stable inks with better switching behaviors and significantly improved lifetime compared to those without surface treatment or treated with non-fluorinated molecules.

The foregoing functionalized pigments have been described with specific application to electronic inks. However, the functionalized pigments may find use in other ink technologies that employ non-aqueous inks. An example of such other ink technology is liquid electrophoretic ink (LEP) used in commercial digital printers.

Further, the foregoing discussion has been directed primarily to stacked cells in an electro-optical display. However, the functionalized pigments disclosed herein may also be employed in lateral cells in an electro-optical display.

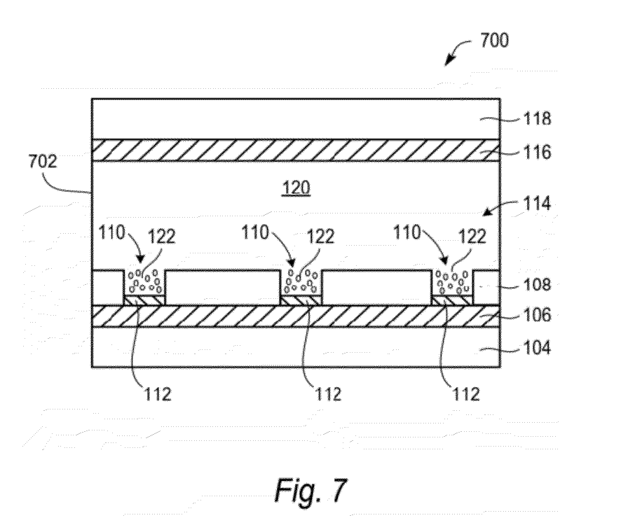

FIG. 7 illustrates a cross-sectional view of one example of lateral electro-optical display 700. Electro-optical display 700 includes a display element 702a. Additional display elements may be disposed laterally in the x and y directions, with each display elements containing inks having colorant particles 122 of different colors.

Each display element 702a is similar to electro-optical display 100a previously described and illustrated with reference to FIG. 1. Each display element 702a may include circular shaped thin layers 110a self-aligned within recess regions 108. Each display element 702a may also include colorant particles 122 having a color (e.g., cyan, magenta, yellow, black, or white) for a full color electro-optical display. In other examples, colorant particles 122 may include other suitable colors for providing an additive or subtractive full color electro-optical display.

What is claimed is:

1. Pigment-based inks with fluorinated material-surface modified pigments, including:
a non-polar carrier fluid; and
pigment particles suspended in the non-polar carrier fluid, the pigment particles having either fluorinated acidic functional groups, which are charged through basic charge directors to give negatively charged pigment dispersions or fluorinated basic functional groups, which are charged through acidic charge directors to give positively charged pigment dispersions.

2. The inks of claim 1 wherein the non-polar carrier fluid is a non-polar solvent selected from the group consisting of hydrocarbons, halogenated or partially halogenated hydrocarbons, and siloxanes.

3. The inks of claim 2 wherein the non-polar solvent is selected from the group consisting of perchoroethylene, cyclohexane, dodecane, mineral oil, isoparaffinic fluids, cyclopentasiloxane, cyclohexasiloxane, cyclooctamethylsiloxane, and combinations thereof.

4. The inks of claim 1 wherein the pigment particles are selected from the group consisting of black pigment particles, yellow pigment particles, magenta pigment particles, red pigment particles, violet pigment particles, cyan pigment particles, blue pigment particles, green pigment particles, orange pigment particles, brown pigment particles, and white pigment particles.

5. The inks of claim 4 wherein the pigment particles are provided with a coating of silica and wherein the pigments have a particle size ranging from about 50 nm to 1 μm and wherein the coating has a thickness of up to about 200 nm.

6. The inks of claim 4 wherein the pigments have fluorinated acidic functional groups and the fluorinated acidic functional groups are selected from the group consisting of —OH, —SH, —COOH, —CSSH, —COSH, —SO₃H, —PO₃H, —OSO₃H, and —OPO₃H.

7. The inks of claim 6 wherein the basic charge directors are selected from those oligomers or polymers that can form reverse micelles which have terminal basic groups consisting of free amine (—NH₂), trialkyamine, R₁R₂N—, pyridines or substituted pyridines, imidazoles or substituted imidazoles.

8. The inks of claim 4 wherein the pigments have fluorinated basic functional groups and the fluorinated basic functional groups are selected from the group consisting of free amine (—NH₂), trialkyamine, R₁R₂N—, pyridines or substituted pyridines, imidazoles or substituted imidazoles.

9. The inks of claim 8 wherein the acidic charge directors are selected from those oligomers or polymers that can form reverse micelles which have the terminal acidic groups consisting of —OH, —SH, —COOH, —CSSH, —COSH, —SO₃H, —PO₃H, —OSO₃H, and —OPO₃H.

10. In combination, an electronic display and an electronic ink,
wherein the electronic display includes:
a first electrode;
a second electrode; and
a display cell defined by a dielectric material between the first electrode and the second electrode, the display cell containing the electronic ink; and
wherein the electronic ink includes:
a non-polar carrier fluid; and
pigment particles suspended in the non-polar carrier fluid, the pigments having either fluorinated acidic functional groups, which are charged through basic charge directors to give negatively charged pigment dispersions or fluorinated basic functional groups, which are charged thorough acidic charge directors to give positively charged pigment dispersions.

11. The combination of claim 10 wherein the electronic display includes a plurality of display cells in a stacked configuration, associated first electrodes and second electrodes, and a plurality of electronic inks of different colors, each display cell containing an electronic ink of a different color.

12. The combination of claim 10 wherein the non-polar carrier fluid is a non-polar carrier fluid selected from the group consisting of hydrocarbons, halogenated or partially halogenated hydrocarbons, and siloxanes.

13. The combination of claim 12 wherein the non-polar carrier fluid is selected from the group consisting of perchoroethylene, cyclohexane, dodecane, mineral oil, isoparaffinic fluids, cyclopentasiloxane, cyclohexasiloxane, cyclooctamethylsiloxane, and combinations thereof.

14. The combination of claim 10 wherein the pigment particles are selected from the group consisting of black pigment particles, yellow pigment particles, magenta pigment particles, red pigment particles, violet pigment particles, cyan pigment particles, blue pigment particles, green pigment particles, orange pigment particles, brown pigment particles, and white pigment particles.

15. The combination of claim 14 wherein the pigments particles are provided with a coating of silica and wherein the pigments have a thickness ranging from about 50 nm to 1 μm and wherein the coating has a thickness of up to about 200 nm.

16. The combination of claim 14 wherein either the pigments have fluorinated acidic functional groups and the fluorinated acidic functional groups are selected from the group consisting of —OH, —SH, —COOH, —CSSH, —COSH, —SO₃H, —PO₃H, —OSO₃H, and —OPO₃H and wherein the basic charge directors are selected from the group consisting of free amine (—NH₂), trialkyamine, R₁R₂N—, pyridines or substituted pyridines, imidazoles or substituted imidazoles or the pigments have fluorinated basic functional groups and the fluorinated basic functional groups are selected from the group consisting of free amine (—NH₂), trialkyamine, R₁R₂N—, pyridines or substituted pyridines, imidazoles or substituted imidazoles and wherein the acidic charge directors are selected from the group consisting of —OH, —SH, —COOH, —CSSH, —COSH, —SO₃H, —PO₃H, —OSO₃H, and —OPO₃H.

17. A process for treating a pigment for use in a pigment-based ink, the method including:
providing a pigment with a coating; and
either reacting the pigment with a fluorinated acidic functional group to form a fluorinated acidic functional groups-modified pigment, which is then charged through a basic charge director to give a negatively charged pigment dispersion; or
reacting the pigment with a fluorinated basic functional group to form a fluorinated basic functional groups-modified pigment, which is then charged through a acidic charge director to give a positively charged pigment dispersion.

18. The process of claim 17 wherein the pigment particles are selected from the group consisting of black pigment particles, yellow pigment particles, magenta pigment particles, red pigment particles, violet pigment particles, cyan pigment particles, blue pigment particles, green pigment particles, orange pigment particles, brown pigment particles, and white pigment particles and wherein the pigment particles are provided with a coating of silica, wherein the pigments have a thickness ranging from about 50 nm to 1 μm and wherein the coating has a thickness of up to about 200 nm.

19. The process of claim 18 wherein the pigments have fluorinated acidic functional groups and the fluorinated acidic functional groups are selected from the group consisting of —OH, —SH, —COOH, —CSSH, —COSH, —SO₃H, —PO₃H, —OSO₃H, and —OPO₃H and wherein the basic charge directors are selected from the group consisting of free amine (—NH₂), trialkyamine, R₁R₂N—, pyridines or substituted pyridines, imidazoles or substituted imidazoles.

20. The process of claim 18 wherein the pigments have fluorinated basic functional groups and the fluorinated basic functional groups are selected from the group consisting of free amine (—NH₂), trialkyamine, R₁R₂N—, pyridines or substituted pyridines, imidazoles or substituted imidazoles and wherein the acidic charge directors are selected from the group consisting of —OH, —SH, —COOH, —CSSH, —COSH, —SO₃H, —PO₃H, —OSO₃H, and —OPO₃H.
